(19) United States
(12) Patent Application Publication
(10) Pub. No.: US 2026/0356858 A1
(43) Pub. Date: Nov. 12, 2026

(54) METHOD FOR PRODUCING A METALLIC LITHIUM DISPERSION AND METHOD FOR PRODUCING AN ALKYLLITHIUM SOLUTION

(71) Applicant: Public Joint Stock Company SIBUR HOLDING, Tyumenskaya oblast (RU)

(72) Inventors: Maksim Vladimirovich LIPSKIH, Tomsk (RU); Albert Alikovich IAKHIN, Kislovka (RU)

(21) Appl. No.: 19/123,908

(22) PCT Filed: Nov. 29, 2023
(86) PCT No.: PCT/RU2023/050277

§ 371 Date: Apr. 24, 2025

(30) Foreign Application Priority Data
Dec. 13, 2022 (RU) 2022132538

(51) Int. Cl. C07F 1/02

(52) U.S. Cl. CPC C07F 1/02

(57) ABSTRACT

This disclosure relates to a process for producing a lithium metal dispersion which can be used in the production of solutions of alkyllithium compounds. More particularly, the disclosure relates to a process for producing a dispersion of lithium metal in an organic solvent by melting lithium metal, dispersing the melted lithium metal under stirring in an organic solvent which has a boiling point of up to 120 °C, followed by cooling to produce a dispersion of lithium metal in an organic solvent. This disclosure further relates to a dispersion of lithium metal in an organic solvent which has a boiling point of up to 120 °C, wherein the lithium metal particles have a particle size greater than 300 microns, and to a process for producing an alkyllithium solution using this lithium metal dispersion.

### FIELD OF THE INVENTION

The present invention relates to a process for producing a lithium metal dispersion which can be used in the production of solutions of alkyllithium compounds.

### BACKGROUND OF THE INVENTION

Alkyllithium compounds (alkyllithiums) are widely used as initiators for polymerization of dienes and copolymerization of dienes, for example, with vinyl aromatic compounds.

Currently, in industry, alkyllithium is usually produced by melting lithium metal, dispersing the resulting lithium melt in a high-boiling solvent, for example, in oil or paraffin, in an inert atmosphere with high-speed stirring, followed by washing the resulting dispersed lithium metal particles from the oil with a solvent, which is also used as a solvent in the subsequent step of alkyllithium synthesis. Alkyl halide is then added to the resulting dispersion of lithium metal in a solvent to produce alkyllithium. The example of said process is disclosed in detail, for example, in patent RU 2691649 (Glukhovskoy V. S., Blinov E. V., Papkov V. N., Zemsky D. N., Stepanov I. M., published Jun. 17, 2019), wherein lithium metal is pre-dispersed in petrolatum oil, followed by washing the dispersed lithium from the oil using nefras (petroleum solvent).

The main disadvantage of this process is the need for additional steps of washing lithium metal particles from oil and separation of the resulting mixture of oil and solvent, each of which involves loss of valuable lithium. In addition, the resulting alkyllithium may contain impurities due to incomplete washing of dispersed lithium particles from oil residues, as well as due to the occurrence of side reactions of lithium with impurities of aromatic and unsaturated compounds that may be contained in the oil.

It is also known that in order to increase the efficiency of alkyllithium synthesis, it is preferable to use lithium metal in the form of particles having a particle size of less than 300 microns (U.S. Pat. No. 5,332,533, FMC Corporation, published Jul. 26, 1994). This is explained by the fact that the reaction of an alkyl halide with lithium occurs mainly on the surface of the metal, therefore the smaller the metal particles, the greater the specific surface area and the faster the reaction will proceed.

Thus, patent RU 2095362 (Shcherban G. T, published Nov. 10, 1997) discloses a process for producing n-butyllithium, carried out in a hydrocarbon solvent and in the presence of an inert gas, wherein in the first step n-butyl chloride is reacted with a lithium metal dispersion having a particle size of from 5 to 300 microns in a reactor at a temperature of from 0 to 60 °C. Then in the second step the reaction mass is hold at a temperature of from 65 to 90 °C. In addition, in the first step, the synthesis of n-butyllithium is carried out at a molar ratio of n-butyl chloride to lithium equal to 0.65-0.85 of the stoichiometrically required, the resulting reaction products are subjected to separation, unreacted lithium is fed back into synthesis at the same ratio of components, the resulting n-butyllithium solution isolated during the separation is sent to the second step of synthesis, which is completed after adding the second part of the n-butyllithium solution and the remaining amount of n-butyl chloride. In addition, in the first step, the synthesis is carried out with continuous circulation of the reaction mass through a condenser and n-butyl chloride is dosed with respect to lithium at a mass rate of 0.25-2.5 hr⁻¹ and introduced preferably at the point with the lowest temperature.

The main disadvantage of the process disclosed therein is the complexity of its practical implementation, as well as the possibility of forming stable suspensions of lithium chloride by-product in n-butyllithium solution under the described conditions of prolonged vigorous mechanical stirring, as a result, the obtained n-butyllithium contains a large amount of lithium chloride not separated during filtration.

U.S. Pat. No. 7,005,083 (SQM Lithium Specialties Limited Partnership, published Feb. 28, 2006) discloses a process for producing alkyllithium in a liquid hydrocarbon solvent selected from the group of liquid saturated aliphatic hydrocarbons containing 5 to 12 carbon atoms, saturated liquid cycloaliphatic hydrocarbons containing 6 to 12 carbon atoms or mixtures thereof, by reacting alkyl halides containing 3 to 16 carbon atoms with metal particles of less than 300 microns in size. Lithium-sodium alloy with a sodium content of 15-34% by weight is used as a metal. Said process allows to obtain alkyllithium of high purity and in a yield of at least 90%.

The disadvantages of said process for producing alkyllithium are that handling of lithium-sodium alloy causes a high risk of fire and explosion and a slurry of lithium and sodium chlorides is formed, which is difficult to separate from the target product.

There is a known method of producing alkyllithium by reacting a lithium dispersion with an alkyl halide in hydrocarbon solvents using lithium metal in the form of a dispersion having a particle size of up to 300 microns, produced by atomisation of molten lithium in an argon atmosphere at a temperature of 200-230 °C (U.S. Pat. No. 7,326,372, CHEMETALL GMBH, published Feb. 5, 2008).

The disadvantages of said method are the need to use a complex device for atomisation of the lithium at a temperature of 200-230 °C and a high fire hazard associated with the method for producing of lithium dispersion.

The use of finely dispersed lithium particles ensures the completeness of the alkyllithium formation reaction, however, it causes technological problems, in particular, problems during the filtration of the reaction mass (clogging of filters with lithium metal), which leads to frequent shutdowns.

In addition, industrial realization of the method of producing alkyllithium using fine particles is associated with the need to use high-performance equipment (stirring device, heat-exchange equipment) both in the preparation of lithium dispersion and in the production of alkyllithium.

There is a known process for producing alkyllithium by reacting lithium metal in the form of pieces having a weight of more than 0.5 grams with alkyl chloride at a molar ratio of lithium to alkyl chloride ranging from 3:1 to 20:1 in hydrocarbon solvents in an inert atmosphere with a slow dosing of alkyl chloride (U.S. Pat. No. 5,523,447, FMC CORP, published Jun. 4, 1996).

The disadvantage of said process is the high lithium to alkyl chloride ratio of 3:1 or higher. It is also possible that unreacted lithium may be entrained in the solution containing the target product and it exits the reactor and clogs pipes and fittings.

Thus, there remains a need to provide a process for producing an alkyllithium solution which overcomes all the aforementioned disadvantages.

### SUMMARY OF THE INVENTION

The object of the present invention is to provide an effective process for producing a dispersion of lithium metal in an organic solvent, which can be used to produce an alkyllithium solution without the need for additional steps of its preparation, thus minimizing the loss of lithium metal, as well as to provide a process for producing an alkyllithium solution using the resulting lithium metal dispersion.

This object is achieved by providing a process for producing a dispersion of lithium metal in an organic solvent by melting lithium metal, dispersing the melted lithium metal under stirring in an organic solvent which has a boiling point of up to 120 °C, followed by cooling to produce a dispersion of lithium metal in an organic solvent.

This object is achieved by providing a dispersion of lithium metal in an organic solvent which has a boiling point of up to 120 °C, wherein the lithium metal particles have a particle size greater than 300 microns.

The term “particle size” in the context of the present invention shall be understood to mean the length of the longest side of a lithium metal particle as determined using an optical microscope.

This object is also achieved by providing a process for producing alkyllithium by reacting lithium metal particles contained in the lithium metal dispersion of the present invention with an alkyl halide.

The technical result achieved by the present invention consists in providing a dispersion of lithium metal in an organic solvent which has a boiling point of up to 120 °C, characterized by optimal size and structure of lithium metal particles, which have high reactivity and can be effectively used for the production of alkyllithium solution, in particular, allow to achieve an alkyllithium yield of more than 85%, which is comparable to the alkyllithium yield achieved using finely dispersed lithium metal particles obtained by dispersing in a high-boiling solvent, for example, in oil.

The technical result achieved by the present invention consists in increasing the efficiency of the process for producing lithium metal dispersion since the solvent used for producing the dispersion is the same solvent used in the process for producing the alkyllithium solution. As a result, the number of steps of the process for producing the lithium metal dispersion is reduced since there is no need to wash the obtained lithium metal particles from a high-boiling solvent, such as oil, with a solvent used in the alkyllithium synthesis step before its use in the process for producing the alkyllithium solution, and there is no need to separate the obtained mixture of solvent and oil after such washing.

In addition, since there is no need to carry out the steps mentioned above, it is possible to minimizes the loss of lithium metal during the implementation of the process for producing lithium metal dispersion, that may occur at each of these steps.

An additional technical result achieved by the present invention consists in reducing the metal consumption of the process for producing lithium metal dispersion, since there is no need to carry out the above steps, requiring the use of additional production units, such as separators.

Furthermore, the process for producing lithium metal dispersion according to the present invention allows for the subsequent production of an alkyllithium solution using the lithium metal particles contained in the dispersion in the same apparatus used to produce the dispersion of lithium metal particles.

### BRIEF DESCRIPTION OF THE DRAWINGS

FIG. 1 is a micrograph of the dispersion of lithium metal in oil, produced according to Example 1, showing that the lithium metal particles have a substantially spherical shape and a particle size of less than 220 microns.

FIG. 2 are micrographs of the lithium metal dispersion, produced by the present process for producing a lithium metal dispersion (according to Example 4), showing that the lithium metal particles have an irregular shape and a particle size greater than 1500 microns.

### DETAILED DESCRIPTION OF THE INVENTION

The following is a detailed description of various aspects and embodiments of the present invention.

The present invention relates to a process for producing a dispersion of lithium metal in an organic solvent by melting lithium metal, dispersing the melted lithium metal under stirring in an organic solvent which has a boiling point of up to 120 °C, followed by cooling to produce a dispersion of lithium metal in an organic solvent.

Lithium metal can be used in any commercially available form, for example, in the form of pieces, pellets, tablets, rods or ribbons. The weight and size of lithium metal can vary and are limited only by the capacity and dimensions of the apparatus in which the lithium metal dispersion is to be prepared.

Commercially available lithium metal with any sodium content may be used as lithium metal. In particular, the sodium content of the lithium metal can vary from 50 to 5000 ppm, preferably from 50 to 2000 ppm, more preferably from 100 to 1500 ppm, more preferably from 150 to 1000 ppm, more preferably from 250 to 500 ppm.

Suitable organic solvents for dispersing include, but are not limited to: non-polar solvents, for example, C5-C7 alkanes, such as n-hexane, n-heptane; cycloalkanes, such as, cyclohexane; or mixtures thereof in various ratios, such as nefras and petroleum ether. Preferably, hexane, cyclohexane or nefras are used, most preferably hexane and nefras, for example, nefras P1 63/75, which is a hexane-heptane fraction. The boiling point of a suitable organic solvent can range from 36 to 120 °C, preferably from 45 to 100 °C, most preferably from 60 to 75 °C.

The weight ratio of organic solvent to lithium metal can be any weight ratio and is selected depending on the desired concentration of the resulting dispersion of lithium metal in the organic solvent, which in turn is determined by the target concentration of the alkyllithium solution produced using the dispersion. In particular, at a target concentration of alkyllithium solution of 2.5M, said ratio can be from 6:1 to 16:1, preferably 9:1 to 14:1, more preferably 10:1 to 13:1.

The melting of the lithium metal is carried out by heating to a temperature of 230 °C, preferably 210 °C, more preferably 200 °C, more preferably 190 °C.

The pressure employed during the process for producing the lithium metal dispersion may be any pressure and it depends on the organic solvent used. In particular, when nefras P1 63/75 is used as the solvent, the pressure may be from 0.3 to 2.5 MPa, preferably from 0.5 to 2 MPa, more preferably from 1 to 1.8 MPa.

Once the required heating temperature is reached the molten lithium metal and organic solvent are stirred to form a dispersion of lithium metal in organic solvent.

The type of stirring device and the stirring speed are not critical when implementing the process of the present invention, any stirring device and stirring speed can be used, provided that the turbulence energy dissipation rate(s) ranging from 3 to 25 m²/s³ is ensured, preferably from 4 to 20 m²/s³, more preferably from 5 to 17 m²/s³. By maintaining the turbulence energy dissipation rate (E) in a given range, it is possible to provide the lithium metal dispersion having the desired particle size and structure. At a turbulence energy dissipation rate (8) below 3 m²/s³, predominantly larger lithium metal particles (larger than 2500 microns) are formed, which are less efficient in their subsequent use in the production of alkyllithium. When the turbulence energy dissipation rate (8) exceeds 25 m²/s³, smaller particles are formed, which according to the prior art should be more efficient in the production of alkyllithium and ensure the completeness of the reaction, however, no significant increase in alkyllithium yield was observed when smaller lithium metal particles were used. In addition, providing such a high dissipation rate is a technological difficulty and leads to an increase in the metal consumption of the apparatus in which the lithium metal dispersion is to be prepared.

The stirring time of the lithium metal and organic solvent may be any time sufficient to produce a lithium metal dispersion having the desired particle size and structure. In some particular embodiments, the stirring time can be from 3 to 20 minutes, preferably from 5 to 15 minutes, more preferably from 8 to 12 minutes.

Upon completion of stirring, the resulting dispersion of lithium metal in organic solvent is cooled to a temperature corresponding to the temperature of alkyllithium production. Cooling of the resulting dispersion of lithium metal in organic solvent can be carried out in any way known in the art, for example, by means of heating devices, which can be either external or internal. In some particular embodiments, external heating devices, such as thermostats, may be utilized, the main purpose of which is to provide a desired temperature by circulating air or a liquid carrier, such as oil.

It is known that cooling is required to be carried out quickly in order to minimize the possibility of sticking of lithium metal particles to form large lithium metal agglomerates, which are less reactive and inefficient in the production of alkyllithium. In some embodiments, cooling from the melting point of the lithium metal to 170 °C is performed at a cooling rate of greater than 4 °C/min, preferably greater than 6 °C/min, more preferably greater than 8 °C/min, most preferably greater than 10 °C/min.

In yet another aspect, the present invention relates to a dispersion of lithium metal in an organic solvent which has a boiling point of up to 120 °C, wherein the lithium metal particles have a particle size greater than 300 microns, preferably from 300 to 5000 microns, more preferably from 300 to 2500 microns. Preferably, the content of particles larger than 2500 microns should not exceed 20%, more preferably 15%, more preferably 10% relative to the total number of lithium metal particles.

The present inventors have found that the lithium metal particles contained in the present dispersion of lithium metal in an organic solvent are irregularly shaped particles.

The present inventors have also found that the bulk density of the lithium metal particles contained in the present dispersion of lithium metal in an organic solvent may be from 0.270 to 0.350 g/ml, preferably from 0.275 to 0.345 g/ml, more preferably from 0.281 to 0.338 g/ml, whereas the bulk density of lithium metal obtained in high-boiling solvents, such as oil, ranges from 0.375 to 0.397 g/ml. Bulk density was determined by gravimetric method as follows: lithium metal particles were dried and purged with argon to remove the solvent, a pre-weighed measuring cylinder was filled with particles to the brim of the cylinder and the cylinder with powder was weighed. Then the bulk density was calculated by the formula:

$$ρ = \frac{m - {m}_{c}}{{V}_{c}} ,$$

where m is the mass of the cylinder with powder, m_{c} is the mass of the empty cylinder, V_{c} is the volume of the cylinder. The authors believe that this indicates that lithium metal particles have a branched surface and therefore exhibit high reactivity and interact efficiently with alkyl halide to produce alkyllithium in high yield.

In yet another aspect, the present invention relates to a process for producing an alkyllithium solution by reacting lithium metal particles contained in a dispersion of lithium metal in an organic solvent and an alkyl halide.

Chlorides, bromides or iodides may be used as alkyl halides, but most preferably chlorides are used The alkyl chloride includes, but is not limited to: methyl chloride, ethyl chloride, n-propyl chloride, n-butyl chloride, sec-butyl chloride, tert-butyl chloride and n-hexyl chloride. Preferred are n-butyl chloride, sec-butyl chloride or tert-butyl chloride.

The molar ratio of lithium metal particles to alkyl halide may be from 1.8 to 4, preferably from 1.9 to 3, more preferably from 2 to 2.5.

The dosing rate of the required amount of alkyl halide added to lithium metal in an organic solvent can be any dosing rate and it is selected so that the temperature of alkyllithium synthesis does not exceed 75 °C, preferably ranges from 50 to 73 °C, more preferably from 60 to 70 °C. If the temperature exceeds 75 °C, a preferential side reaction of n-butyllithium with n-butyl chloride to form lithium chloride and octane may occur.

The pressure employed during the process for producing alkyllithium may be any pressure and it depends on the organic solvent used. In particular, when nefras P1 63/75 is used as the solvent, the pressure may be from 0 to 2.5 MPa, preferably from 0 to 1.5 MPa, more preferably from 0 to 0.2 MPa.

The time of alkyllithium synthesis can be any time sufficient to achieve zero alkyl halide content in the reaction mass. In some embodiments, the time of alkyllithium synthesis can be up to 24 hours, preferably up to 18 hours, most preferably up to 10 hours.

The process for producing an alkyllithium solution must be carried out in a reactor made of a material inert to the substances used in the process for producing an alkyllithium solution. In particular, the process for producing an alkyllithium solution can be carried out in a titanium reactor, a stainless steel reactor or an enameled reactor.

The resulting alkyllithium solution is subjected to filtration to purify it from lithium chloride sludge, where the content of lithium chloride sludge in the alkyllithium solution should not exceed 0.4%, preferably the sludge should be completely absent. Filtration can be carried out at any filtration temperature known from the prior art, preferably at a temperature of from 20 to 40 °C, more preferably from 20 to 30 °C, using any filtration devices known from the prior art, for example, filters with porous filter baffles, nutsche filters, it is preferable to use nutsche filters. Additionally, the lithium chloride sludge remaining on the filter can be neutralized, for example, by treatment with an aqueous-alcoholic solution.

The filtered alkyllithium solution can be further diluted with an organic solvent to obtain the required concentration for subsequent use as an initiator in the polymerization of dienes and copolymerization of dienes, for example, with vinyl aromatic compounds, as well as to bring it into line with the Agreement Concerning the International Carriage of Dangerous Goods by Road (ARD). In particular, n-butyllithium belongs to the class of substances capable of spontaneous combustion (Class 4.2) and therefore it is only transported as a solution with a concentration of n-butyllithium of from 15 to 90%, preferably from 15 to 25%.

The alkyllithium produced in accordance with the process of the present invention may include, but is not limited to: propyllithium, butyllithium, amyllithium, hexyllithium, preferably butyllithium.

The use of the obtained alkyllithium solution as an initiator for polymerization of dienes and copolymerization of dienes, for example, with vinyl aromatic compounds, has advantages over other commercially available alkyllithium solutions, this is due to the essential features of both the process for producing a lithium metal dispersion and the process for producing alkyllithium using said dispersion.

### IMPLEMENTATION OF THE INVENTION

### Test Methods

### Screening

Determination of the particle size distribution of lithium metal powder was carried out by screening using a vibrating screen. For this purpose, screens having mesh sizes of 100 microns, 350 microns, 600 microns, 1000 microns, 1600 microns and 2500 microns were used. Each obtained fraction (residue on the screen) was weighed and expressed as a percentage of the total mass of the powder.

### Optical Microscopy

The shape and size of the lithium metal particles produced as a dispersion in an organic solvent according to the process of the present invention were examined by taking micrographs using Leica DM2700M optical microscope with transmitted light at 50× magnification. Lithium metal particles were applied to a slide and analyzed without prior sample preparation. The particle size was measured using Axalit software.

### Example 1 (Comparative)

2 kg of mineral oil and 400 g of lithium pieces were added to a 5 L reactor, then the reactor contents were heated to 200 °C, after which the contents were stirred at 2000 rpm and after 10 minutes the cooling of the resulting lithium dispersion to 20 °C was started. The resulting dispersion of lithium in oil was washed with nefras (P1 63/75), dried under a stream of argon to afford the lithium metal powder. The particle size distribution of the lithium powder was as follows: 60% particles ranging from 100 to 350 microns, 17% particles ranging from 350 to 600 microns, the remaining particles were smaller than 100 microns.

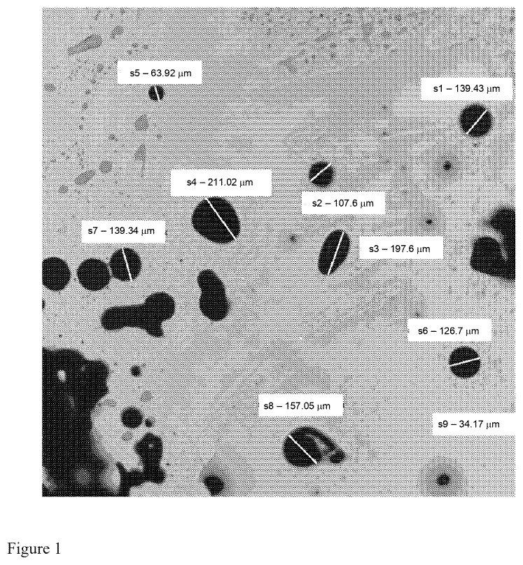

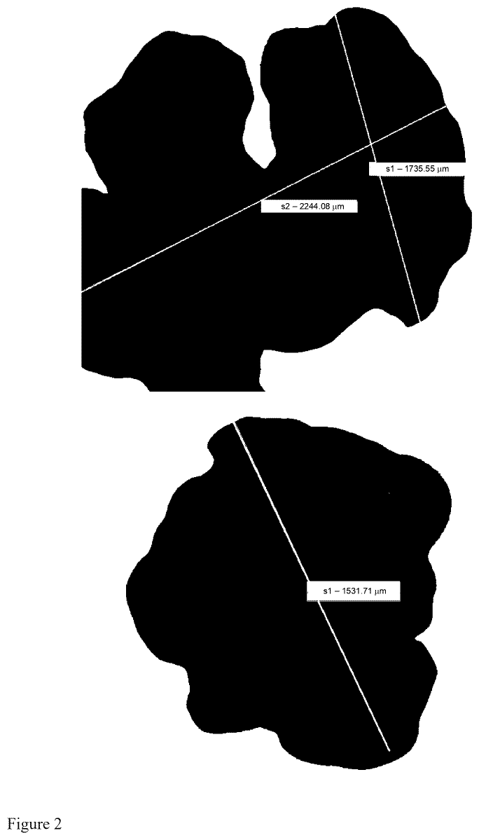

FIG. 1 is a micrograph of the resulting dispersion of lithium metal in oil, showing that the lithium metal particles have a substantially spherical shape and a particle size of less than 220 microns.

150 g of lithium powder and 2 kg of nefras were added to the reactor, then the contents were heated to 60 °C, then 1 kg of n-butyl chloride was dosed over 7 hours so that the reaction temperature did not exceed 70 °C. Upon completion of dosing of n-butyl chloride, the reaction mass was kept for 8 hours at a temperature of 65 °C. The yield of n-butyllithium was 99.3%.

### Example 2 (Comparative)

2 kg of mineral oil and 400 g of lithium pieces were added to a 5 L reactor, then the reactor contents were heated to 200 °C, after which the contents were stirred at 2000 rpm and after 10 minutes the cooling of the resulting lithium dispersion to 20 °C was started. The resulting dispersion of lithium in oil was washed with nefras, lithium was dried under a stream of argon. The particle size distribution of the lithium powder was as follows: 40% particles ranging from 100 to 350 microns, 45% particles ranging from 350 to 600 microns, the remaining particles were smaller than 100 microns.

150 g of lithium powder and 2 kg of nefras were added to the reactor, then the contents were heated to 60 °C, then 1 kg of n-butyl chloride was dosed over 7 hours so that the reaction temperature did not exceed 70 °C. Upon completion of dosing of n-butyl chloride, the reaction mass was kept for 8 hours at a temperature of 65 °C. The yield of n-butyllithium was 82.4%.

### Example 3 (According to the Present Invention)

150 g of lithium pieces and 2 kg of nefras (P1 63/75) were added to a 5 L reactor, the reactor contents were heated to 200 °C, after which the contents were stirred at 2000 rpm (corresponds to ε of 8 m²/s³) and after 10 minutes the cooling procedure was started, during which cooling from 200 to 170 °C was carried out within 3 minutes and subsequent cooling to 20 °C was carried out at a moderate rate. Lithium was dried under a stream of argon.

The particle size distribution of the lithium powder was as follows: 5% particles smaller than 600 microns, 20% particles ranging from 600 to 1000 microns, 38% particles ranging from 1000 to 1600 microns, 28% particles ranging from 1600 to 2500 microns, 9% particles larger than 2500 microns.

A series of experiments were also carried out under similar conditions and the particle size distribution was determined, it varies in the following ranges: 5-7% particles smaller than 600 microns, 19-25% particles ranging from 600 to 1000 microns, 32-38% particles ranging from 1000 to 1600 microns, 28-30% particles ranging from 1600 to 2500 microns, less than 10% particles larger than 2500 microns.

### Example 3.1

To 150 g of lithium powder (fraction with a particle size less than 600 microns) in 2 kg of nefras, 1 kg of n-butyl chloride was dosed over about 4.5 hours so that the reaction temperature did not exceed 62-70 °C. Strong exotherm and high reactivity of lithium were observed. Upon completion of dosing of n-butyl chloride, the reaction mass was kept for 5 hours at a temperature of 65 °C. The yield of n-butyllithium was 99.4%.

### Example 3.2

The preparation of n-butyllithium was performed in analogy to Example 3.1, except that a lithium fraction with a particle size of from 600 to 1000 microns was used. The yield of n-butyllithium was 99.3%.

### Example 3.3

The preparation of n-butyllithium was performed in analogy to Example 3.1, except that a lithium fraction with a particle size of from 1000 to 1600 microns. The yield of n-butyllithium was 99.2%.

### Example 3.4

The preparation of n-butyllithium was performed in analogy to Example 3.1, except that a lithium fraction with a particle size of from 1600 to 2500 microns. The yield of n-butyllithium was 99.3%.

### Example 3.5

The preparation of n-butyllithium was performed in analogy to Example 3.1, except that a lithium fraction with a particle size greater than 2500 microns. The yield of n-butyllithium was 85.8%.

### Example 4 (According to the Present Invention)

150 g of lithium pieces and 2 kg of nefras (P1 63/75) were added to a 5 L reactor, the reactor contents were heated to 200 °C, after which the contents were stirred at 2000 rpm (corresponds to ε of 8 m²/s³) and after 10 minutes the cooling procedure was started, during which cooling from 200 to 170 °C was carried out within 3 minutes and subsequent cooling to 60 °C was carried out at a moderate rate. No screening of lithium powder was performed. Then 1 kg of n-butyl chloride was dosed into the reactor over 7 hours so that the reaction temperature did not exceed 62-70 °C. Upon completion of dosing of n-butyl chloride, the reaction mass was kept for 8 hours at a temperature of 65 °C. The yield of n-butyllithium was 99.0%.

The particle size distribution of the lithium powder was as follows: 5% particles smaller than 600 microns, 20% particles ranging from 600 to 1000 microns, 38% particles ranging from 1000 to 1600 microns, 28% particles ranging from 1600 to 2500 microns, 9% particles larger than 2500 microns.

A series of experiments were also carried out under similar conditions and the particle size distribution was determined, it varies in the following ranges: 5-7% particles smaller than 600 microns, 19-25% particles ranging from 600 to 1000 microns, 32-38% particles ranging from 1000 to 1600 microns, 28-30% particles ranging from 1600 to 2500 microns, less than 10% particles larger than 2500 microns.

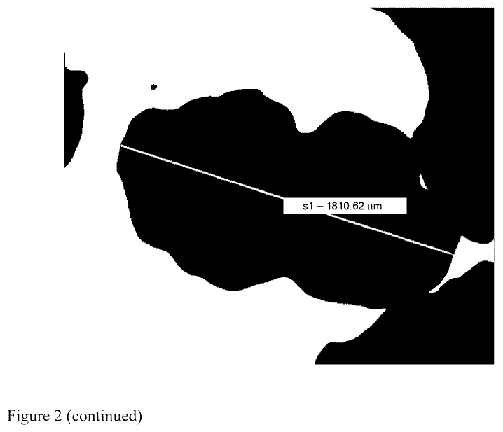

FIG. 2 are micrographs of the resulting dispersion of lithium metal in nefras, showing that the lithium metal particles have an irregular shape and a particle size greater than 1500 microns.

### Example 5 (According to the Present Invention)

The preparation of n-butyllithium was performed in analogy to Example 4, except that during dispersing, stirring was carried out at 1200 rpm (corresponds to ε of 3.2 m²/s³). The yield of n-butyllithium was 88.7%.

The particle size distribution of the lithium powder was as follows: 5% particles smaller than 600 microns, 18% particles ranging from 600 to 1000 microns, 28% particles ranging from 1000 to 1600 microns, 32% particles ranging from 1600 to 2500 microns, 17% particles larger than 2500 microns.

A series of experiments were also carried out under similar conditions and the particle size distribution was determined, it varies in the following ranges: 3-5% particles smaller than 600 microns, 14-20% particles ranging from 600 to 1000 microns, 28-35% particles ranging from 1000 to 1600 microns, 36-43% particles ranging from 1600 to 2500 microns, less than 20% particles larger than 2500 microns.

### Example 6 (Comparative)

The preparation of n-butyllithium was performed in analogy to Example 4, except that during dispersing, stirring was carried out at 800 rpm (corresponds to ε of 2.5 m²/s³). The yield of n-butyllithium was 78.6%.

The particle size distribution of the lithium powder was as follows: 1% particles smaller than 600 microns, 7% particles ranging from 600 to 1000 microns, 14% particles ranging from 1000 to 1600 microns, 54% particles ranging from 1600 to 2500 microns, 24% particles larger than 2500 microns.

A series of experiments were also carried out under similar conditions and the particle size distribution was determined, it varies in the following ranges: less than 2% particles smaller than 600 microns, 5-12% particles ranging from 600 to 1000 microns, 14-22% particles ranging from 1000 to 1600 microns, 51-61% particles ranging from 1600 to 2500 microns, less than 30% particles larger than 2500 microns.

### Example 7 (Comparative)

The preparation of n-butyllithium was performed in analogy to Example 4, except that cooling from 200 to 170 °C was carried out within 9 minutes. The yield of n-butyllithium was 76.8%.

The particle size distribution of the lithium powder was as follows: 1% particles smaller than 600 microns, 7% particles ranging from 600 to 1000 microns, 15% particles ranging from 1000 to 1600 microns, 56% particles ranging from 1600 to 2500 microns, 21% particles larger than 2500 microns.

A series of experiments were also carried out under similar conditions and the particle size distribution was determined, it varies in the following ranges: 3-5% particles smaller than 600 microns, 14-20% particles ranging from 600 to 1000 microns, 28-35% particles ranging from 1000 to 1600 microns, 36-43% particles ranging from 1600 to 2500 microns, less than 20% particles larger than 2500 microns.

### Example 8 (According to the Present Invention)

150 g of lithium pieces and 2 kg of nefras (C2-80/120) were added to a 5 L reactor, the reactor contents were heated to 200 °C, after which the contents were stirred at 2000 rpm (corresponds to ε of 8 m²/s³) and after 10 minutes the cooling procedure was started, during which cooling from 200 to 170 °C was carried out within 3 minutes and subsequent cooling to 60 °C was carried out at a moderate rate. No screening of lithium powder was performed. Then 1 kg of n-butyl chloride was dosed into the reactor over 7 hours so that the reaction temperature did not exceed 62-70 °C. Upon completion of dosing of n-butyl chloride, the reaction mass was kept for 8 hours at a temperature of 65 °C. The yield of n-butyllithium was 99.0%.

The particle size distribution of the lithium powder was as follows: 5% particles smaller than 600 microns, 20% particles ranging from 600 to 1000 microns, 38% particles ranging from 1000 to 1600 microns, 28% particles ranging from 1600 to 2500 microns, 9% particles larger than 2500 microns.

A series of experiments were also carried out under similar conditions and the particle size distribution was determined, it varies in the following ranges: 5-7% particles smaller than 600 microns, 19-25% particles ranging from 600 to 1000 microns, 32-38% particles ranging from 1000 to 1600 microns, 28-30% particles ranging from 1600 to 2500 microns, less than 10% particles larger than 2500 microns.

### Example 9 (According to the Present Invention)

150 g of lithium pieces and 2 kg of hexane were added to a 5 L reactor, the reactor contents were heated to 200 °C, after which the contents were stirred at 2000 rpm (corresponds to ε of 8 m²/s³) and after 10 minutes the cooling procedure was started, during which cooling from 200 to 170 °C was carried out within 3 minutes and subsequent cooling to 60 °C was carried out at a moderate rate. No screening of lithium powder was performed. Then 1 kg of n-butyl chloride was dosed into the reactor over 7 hours so that the reaction temperature did not exceed 62-70 °C. Upon completion of dosing of n-butyl chloride, the reaction mass was kept for 8 hours at a temperature of 65 °C. The yield of n-butyllithium was 99.3%.

The particle size distribution of the lithium powder was as follows: 5% particles smaller than 600 microns, 25% particles ranging from 600 to 1000 microns, 35% particles ranging from 1000 to 1600 microns, 28% particles ranging from 1600 to 2500 microns, 7% particles larger than 2500 microns.

A series of experiments were also carried out under similar conditions and the particle size distribution was determined, it varies in the following ranges: 5-7% particles smaller than 600 microns, 19-25% particles ranging from 600 to 1000 microns, 32-38% particles ranging from 1000 to 1600 microns, 28-30% particles ranging from 1600 to 2500 microns, less than 10% particles larger than 2500 microns.

### Example 10 (According to the Present Invention)

150 g of lithium pieces and 2 kg of heptane were added to a 5 L reactor, the reactor contents were heated to 200 °C, after which the contents were stirred at 2000 rpm (corresponds to ε of 8 m²/s³) and after 10 minutes the cooling procedure was started, during which cooling from 200 to 170 °C was carried out within 3 minutes and subsequent cooling to 60 °C was carried out at a moderate rate. No screening of lithium powder was performed. Then 1 kg of n-butyl chloride was dosed into the reactor over 7 hours so that the reaction temperature did not exceed 62-70 °C. Upon completion of dosing of n-butyl chloride, the reaction mass was kept for 8 hours at a temperature of 65 °C. The yield of n-butyllithium was 99.2%.

The particle size distribution of the lithium powder was as follows: 6% particles smaller than 600 microns, 20% particles ranging from 600 to 1000 microns, 37% particles ranging from 1000 to 1600 microns, 29% particles ranging from 1600 to 2500 microns, 8% particles larger than 2500 microns.

A series of experiments were also carried out under similar conditions and the particle size distribution was determined, it varies in the following ranges: 5-7% particles smaller than 600 microns, 19-25% particles ranging from 600 to 1000 microns, 32-38% particles ranging from 1000 to 1600 microns, 28-30% particles ranging from 1600 to 2500 microns, less than 10% particles larger than 2500 microns.

1. A process for producing a dispersion of lithium metal in an organic solvent by melting lithium metal, dispersing the melted lithium metal under stirring in an organic solvent which has a boiling point of up to 120 °C, followed by cooling to produce a dispersion of lithium metal in an organic solvent.

2. The process of claim 1, wherein the lithium metal particles have a particle size greater than 300 microns.

3. The process of claim 1, wherein the content of the particles larger than 2500 microns should not exceed 20 relative to the total number of lithium metal particles.

4. The process of claim 1, wherein the organic solvent used is a non-polar organic solvent.

5. The process of claim 1, wherein the non-polar organic solvent used is a C5-C7 alkane, a cycloalkane, or a mixture thereof in various ratios.

6. The process of claim 5, wherein the non-polar organic solvent used is hexane, cyclohexane or nefras.

7. The process of claim 1, further comprising stirring is carried out at turbulence energy dissipation rate (ε) of from 3 to 25 m²/s³.

8. The process of claim 1, further comprising cooling is carried out at a rate of more than 4 °C/min.

9. A dispersion of lithium metal in an organic solvent which has a boiling point of up to 120 °C, wherein the lithium metal particles have a particle size greater than 300 microns.

10. The dispersion of claim 9, wherein the dispersion is for use in the production of alkyllithium solution.

11. The dispersion of claim 9, wherein lithium metal particles have a size of from 300 to 5000 microns.

12. The dispersion of claim 9, wherein the content of the particles larger than 2500 microns should not exceed 20% relative to the total number of lithium metal particles.

13. The dispersion of claim 9, wherein the organic solvent used is a non-polar organic solvent.

14. The dispersion of claim 9, wherein the non-polar organic solvent used is a C5-C7 alkane, a cycloalkane, or a mixture thereof in various ratios.

15. The dispersion of claim 14, wherein the non-polar organic solvent used is hexane, cyclohexane or nefras.

16. The dispersion of claim 9, wherein the lithium metal particles have an irregular shape.

17. The dispersion of claim 9, wherein the lithium metal particles have a branched structure.

18. The dispersion of claim 17, wherein the lithium metal particles have a bulk density of from 0.270 to 0.350 g/ml.

19. A dispersion of lithium metal in an organic solvent produced by the process of claim 1.

20. A process for producing an alkyllithium solution by reacting lithium metal particles contained in the lithium metal dispersion of claim 9.

21. The process of claim 20, wherein the alkyl halide used is an alkyl chloride, an alkyl bromide or an alkyl iodide.

22. The process of claim 21, wherein the alkyl chloride used is methyl chloride, ethyl chloride, n-propyl chloride, n-butyl chloride, sec-butyl chloride, tert-butyl chloride and n-hexyl chloride.

23. The process of claim 20, wherein the dosing of alkyl halide to lithium metal in an organic solvent is carried out so that the temperature of the alkyllithium synthesis does not exceed 75 °C.

24. The process of claim 1, wherein the lithium metal particles have a particle size greater from 300 to 5000.

25. The process of claim 1, wherein the lithium metal particles have a particle size greater from 300 from 2500 microns.

26. The dispersion of claim 9, wherein the lithium metal particles have a size of from 300 to 2500 microns.

27. A process for producing an alkyllithium solution by reacting lithium metal particles contained in the lithium metal dispersion of claim 19 with an alkyl halide.
